(19) United States
(12) Patent Application Publication
(10) Pub. No.: US 2002/0073768 A1
(43) Pub. Date: Jun. 20, 2002

(54) Fluid flow sensors & leak detection systems

(76) Inventor: George Malcolm Swift Joynes, Pine Walk (GB)

Correspondence Address: CROWELL & MORING, L.L.P., P.O. Box 14300, Washington, DC, 20044-4300, US

(21) Appl. No.: 09/942,926

(22) Filed: Aug. 31, 2001

(30) Foreign Application Priority Data
Sep. 1, 2000 (GB) 0021370 . 2
Sep. 1, 2000 (GB) 0021374 . 4
Jul. 26, 2001 (GB) 0118218 . 7

(51) Int. Cl. G01N 29/00

(52) U.S. Cl. 73/40.5 A; 73/592

(57) ABSTRACT

Described herein is a method for determining the presence of a leakage in a fluid system, for example, a domestic plumbing system. The method comprises measuring vibration spectra relating to fluid flow in the system and comparing the measured spectra with reference spectra to determine the presence of a leakage. A simple sensor (12) is attached to a pipe (10) for measuring the vibration and is connected to a processing unit (14) via wired connection (18). The sensor (12) may also be provided with an amplifier/buffer (16) and a battery pack (20). The sensor is used in a leakage detection system which is also described.

The present invention relates to improvements in or relating to fluid flow sensors and leak detection systems, and is more particularly, although not exclusively, concerned with water flow sensors and leak detection systems in plumbing systems.

There are many different types of flow meter available on the market, with differing capabilities, in terms of technical performance, such as precision, accuracy, repeatability, capacity, flow direction sensitivity, sensitivity to fluid type, etc. However, all such meters are too complicated or, in any case, too expensive to be considered for use in a simple and inexpensive leak or flow detection system.

In domestic situations, the plumbing system is usually quite reliable. However, in terms of functionality and freedom from leakages or overflows, even a single leak within the confines of the house can be extremely expensive and disruptive to those living there. One example of the risks to which most people are exposed is that washing machines are usually permanently connected to the water mains system, and virtually no-one turns off the taps which may be provided on the mains/hot water pipes leading to the machine between periods of use. Whether the machine is working or not, it may be the case that no-one is in its vicinity or even in the house. While many people may not have personally experienced a major leakage, such as a failure of the joints to the flexible pipes that lead to the machine, they would be able to say they knew of relatives or friends to whom this had once occurred. Awareness of the threat is therefore likely to be fairly high in the public mind, and so means to avert such problems could be attractive.

Another example of the risks is flooding caused by burst pipes in the loft or attic which are connected to a cold water tank. It will be appreciated that this scenario has greater potential for damage than leakage at a washing machine.

In addition to the above, the advent of water metering has made the inadvertent wastage of water of greater importance to the home-owner (and also to the water companies, who wish to foster the more responsible and economical use of what is now a far from abundant resource in some areas or times of the year).

It is therefore an object of the present invention to provide a novel system for detecting the presence of leaks in premises of a water consumer and for alerting someone at the premises in which such a system is fitted to the presence of such leaks. The system may be used either in domestic premises or elsewhere.

It is therefore an object of the present invention to provide a method using a simple flow meter or sensor which is relatively inexpensive.

In accordance with one aspect of the present invention, there is provided method of determining leakage from a fluid system comprising sensing the vibrations induced by passage of the fluid through the leakage, segmenting the sensed vibrations into at least two spectral bands, comparing the amplitudes of the spectral bands with predetermined values to determine the flow rate.

In accordance with a second aspect of the invention there is provided apparatus for determining leakage from a fluid system and a further aspect of the invention there is provided a leakage detection system.

The sensor may include a piezo-electric material. Alternatively, the sensor may include a PVDF film.

In accordance with the present invention, a flow meter or sensor has been designed to sell, as part of a leakage detection system, for a maximum of about £120. However, in order to achieve this price target, it is necessary to sacrifice to some degree such performance factors as accuracy, flow direction sensitivity, repeatability, and this has implications for the system in which the flow meter or sensor(s) is/are to be used.

For a better understanding of the present invention, reference will now be made, by way of example only, to the accompanying drawings in which:

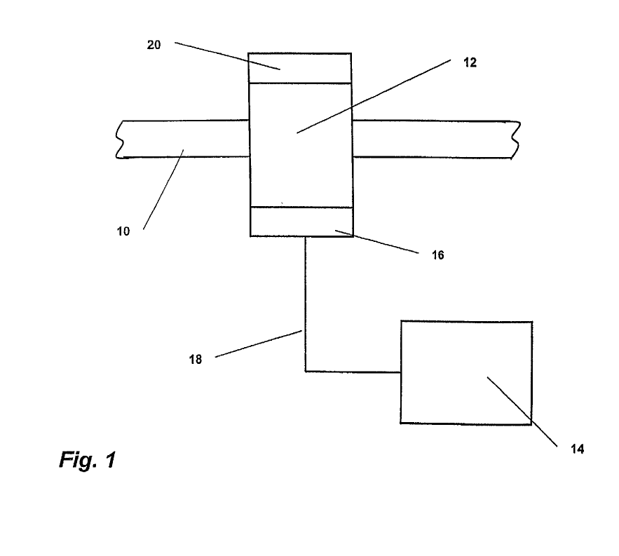

FIG. 1 is a schematic block diagram of a flow meter or sensor arrangement for implementing the method of the present invention;

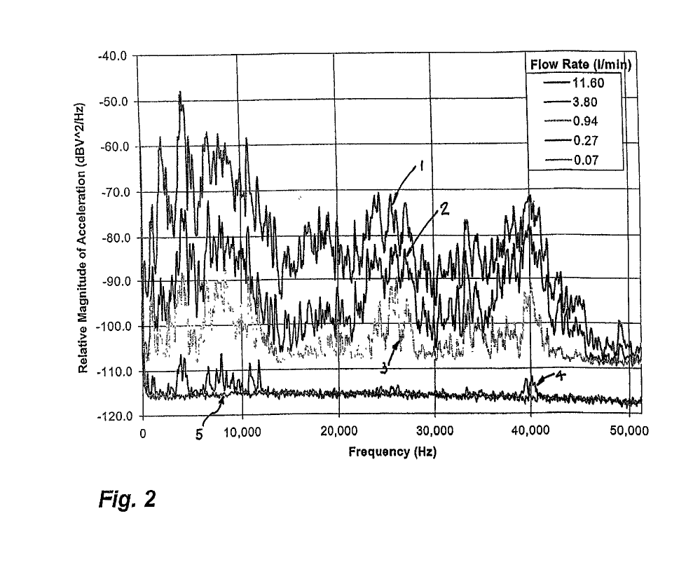

FIG. 2 is a graph illustrating inlet pipe vibration spectra at various flow rates;

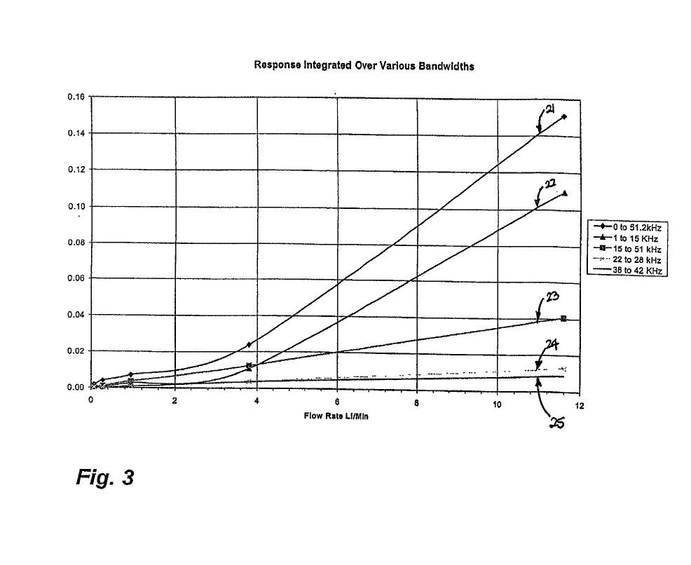

FIG. 3 is a graph illustrating signal power against flow rate through a tap for various bandwidths;

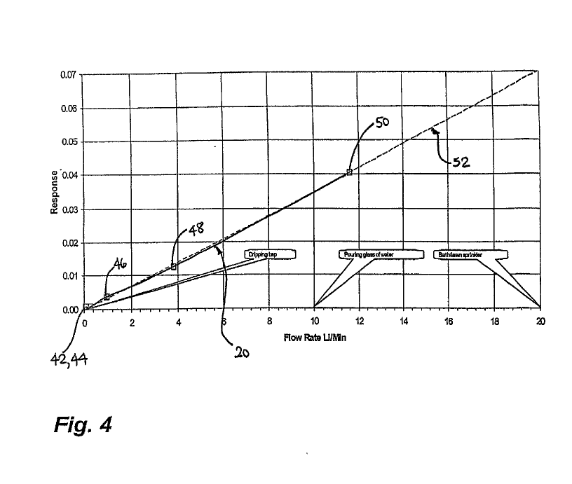

FIG. 4 is a graph illustrating signal power against flow rate through a tap for a bandwidth of 15 to 51 kHz;

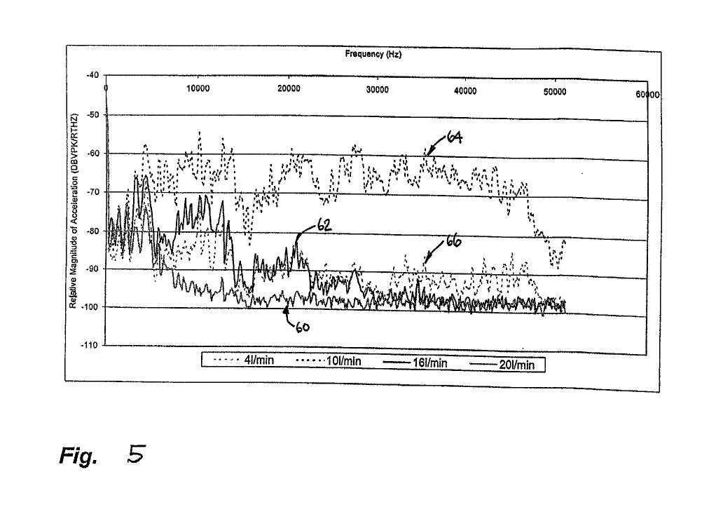

FIG. 5 illustrates spectra taken with four flow rates on a laboratory system;

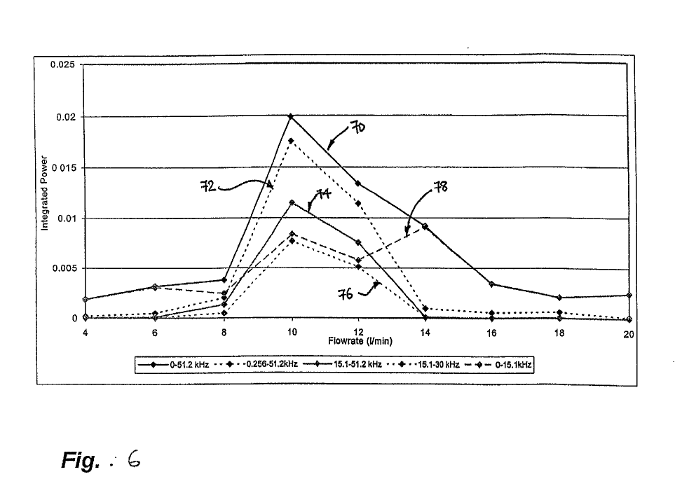

FIG. 6 illustrates the resulting power versus flow rate plots for various bandwidths on the laboratory system;

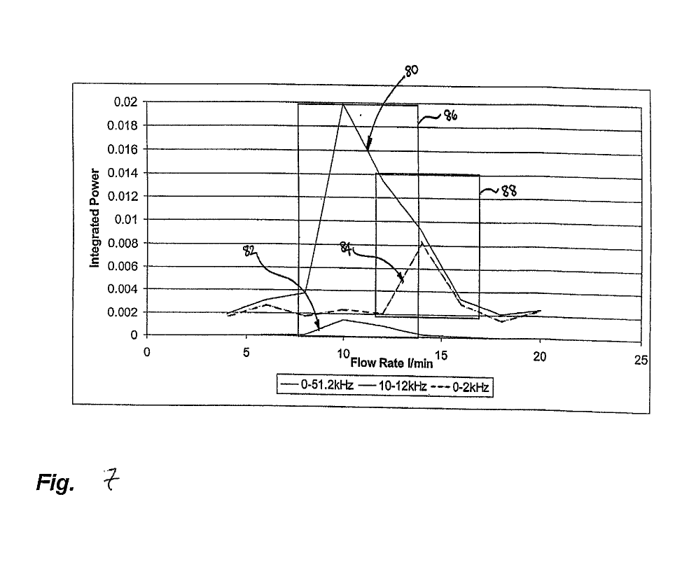

FIG. 7 illustrates flow rate measurements over narrow bandwidths;

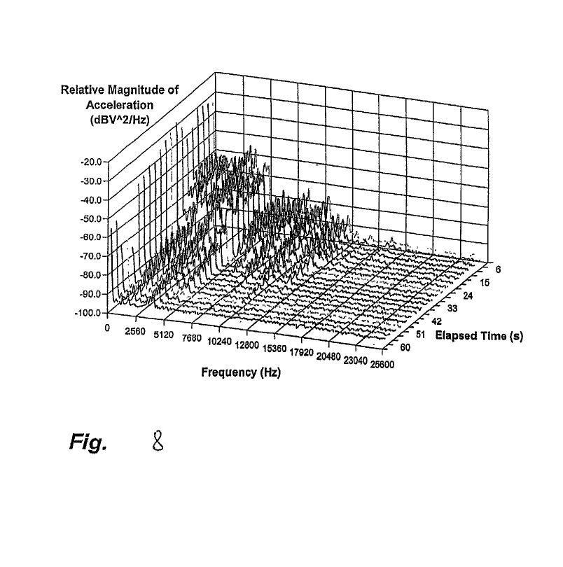

FIG. 8 is a graph illustrating inlet pipe vibration spectrum history during a cistern refill;

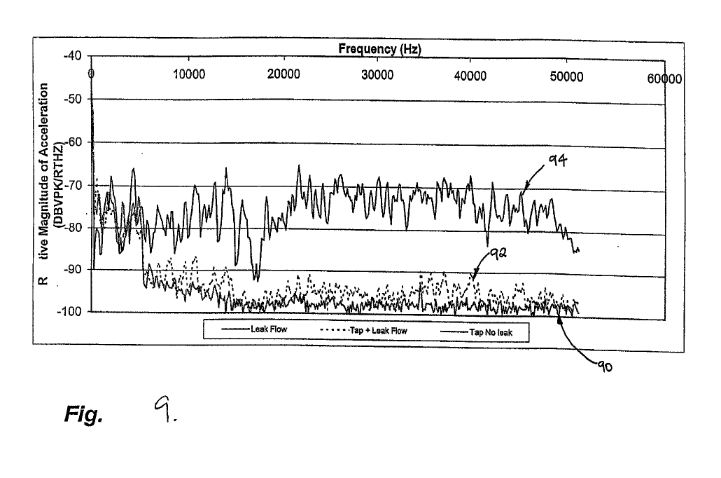

FIG. 9 illustrates the effect of a leak in a system, and

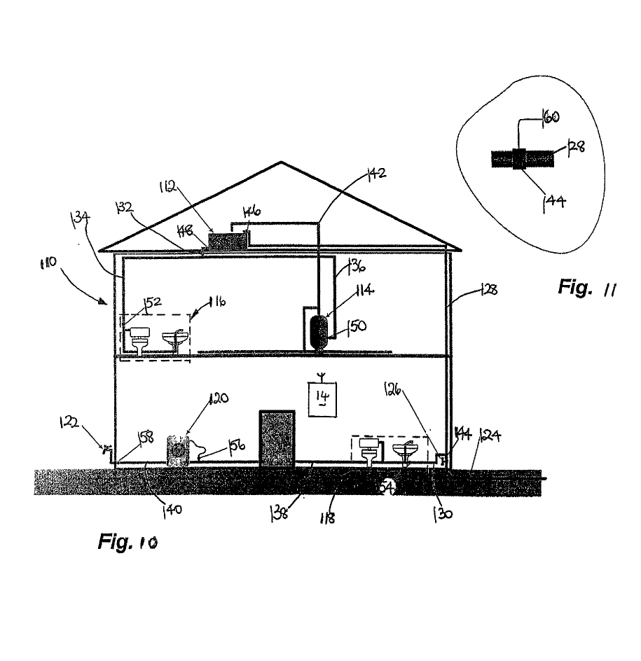

FIGS. 10 and 11 show a leak detection system in accordance with the invention.

Although the present invention will be described with reference to water in a domestic plumbing system, it will be appreciated that it is equally applicable to other fluid systems. The term ‘fluid’ herein is intended to encompass both liquids and gases.

In accordance with the present invention, a flow meter or sensor is utilised which makes use of the phenomenon of fluid flowing in pipes giving rise to acoustically- and seismically-coupled emissions. These emissions vary in amplitude and spectral content as the flow rate changes, and are affected, in varying degrees, by the size of pipe, what the pipe is made of, and by the presence of any bends or connections near to a point at which the emissions are measured.

Such a flow meter or sensor can be clipped or similarly attached to the pipe in which the measurement is to be made. Naturally, the pipe may have a diameter which ranges in size from a few millimeters (small) to up to hundreds of millimeters or perhaps bigger still (large).

The flow meter or sensor can be fabricated from piezo-electric material of various types, as is commonly used in accelerometers and other vibration measurement components. Although sensors using piezo-electric materials are likely to be prime candidates for inexpensive flow meters, other seismic sensors can be considered for any particular application. For example, PVDF films may also be of use in some circumstances, as well as other strain gauges, geophones and/or hydrophones.

In FIG. 1, a portion of a pipe 10 is shown. A sensor 12 is simply clipped to the pipe 10 at a measurement position, for example, using, a Jubilee clip or similar device. Some coupling paste or wax (not shown) is applied to the sensor 12 to enhance the contact with the pipe 10. Readings taken by the sensor 12 are sent to a processing unit 14, which may be located, adjacent the sensor 12 or may be remote therefrom.

If the processing unit 14 is remote from the sensor 12, the sensor 12 may include an electronic pre-amplifier/buffer 16 for boosting the signal from the sensor 12 for transmission to the processing unit 14. The sensor 12 may be connected to the processing unit 14 by means of a wired connection 18 as shown in FIG. 1. Alternatively, signals from the sensor 12 may be transmitted by radio or other medium to the processing unit 14. Also, included in the sensor 12 is a power pack 20 for providing the necessary power for its operation. Naturally, various other means of powering the sensor 12 may be used, for example, remote powering, extracting power from the pipe flow or coupling the sensor 12 to the mains electricity supply.

Experiments were carried out on a domestic plumbing system to indicate the basis of operation of a sensor in accordance with the present invention. The plumbing system used consisted of 15 mm outside-diameter, soldered copper piping. Vibration measurements were taken at a point on an inlet pipe to the system close to the main stopcock as water flowed from a tap some 2.5 m away from the main stopcock. There were no other flows in the system whilst these measurements were taken.

An accelerometer was fixed onto the wall of the inlet pipe with a thin layer of special wax, and was oriented to measure the radial motion of the wall. A small, light accelerometer was used, which would not greatly influence the motion of the pipe. Different flow rates were used and vibration spectra obtained are shown in FIG. 2.

FIG. 2 illustrates the relative magnitude of acceleration against frequency for five different flow rates and Table 1 below gives the relationship between the lines and the flow rate.

TABLE 1

| Curve no. | 1 | 2 | 3 | 4 | 5 |
|---|---|---|---|---|---|
| Flow rate | 11.6 | 3.8 | 0.94 | 0.27 | 0.07 |
| (l/min) | | | | | |

As can be seen from FIG. 2, at higher flow rates, strong vibration is measured over a wide range of frequencies. The vibration spectra have many peaks and troughs, and this structure does not vary much with flow rate. However, the vibration level increases strongly with flow rate at all frequencies.

Below a flow rate of about 0.071/min (curve 5), there are no detectable pipe vibrations above the fairly flat noise level. With a flow rate of 0.271/min (curve 4), there is a detectable vibration. The minimum detectable flow rate thus lies somewhere between 0.07 and 0.271/min, for this particular configuration of water pipes and vibration sensor.

However, it will be appreciated that the data shown in FIG. 2 is system related, and will vary from system to system. The data will also vary for different sensors in the same system.

A system of soldered or compression-jointed copper pipes would be expected to have many resonances and anti-resonances, which might explain the many peaks and troughs in the measured spectra. The attenuation of the piping would also be expected to increase with frequency, and this is borne out by measurements made with an outlet some 15 m away from the measurement point, where the spectral energy falls off at much lower frequencies and the shape of the spectra is different.

The vibrations are likely to be generated not by the flow in the inlet pipe but by flow through the outlet tap or other orifice. They are then transmitted, as sound in the water and/or pipe vibrations, to the inlet pipe. The transmission characteristics of the pipe network will thus have a strong influence on the vibration picked up at the sensor position.

The foregoing suggests that a seismic sensor will not measure just local-flow and the vibrations it senses could arise anywhere on the piping network. The distance over which this can be achieved will depend on the frequency band being examined, and this attribute could be used to distinguish between flows which are near to or further away from the position of the sensor.

From the results for flows through the tap as illustrated in FIG. 2, curves showing signal power versus flow rate have been produced for a number of different frequency bandwidths as shown in FIG. 3. The signal response from the sensor was integrated over various frequency bandwidths as shown in Table 2 below.

TABLE 2

| Curve no. | 21 | 122 | 23 | 24 | 25 |
|---|---|---|---|---|---|
| Bandwidth | 0-51.2 | 1-15 | 15-51 | 122-128 | 138-142 |
| (kHz) | | | | | |

As shown in FIG. 3, if a bandwidth from 15 kHz to 51 kHz is chosen (curve 23), an almost linear relationship results. Wider bandwidths, extending downwards to frequencies below about 110 kHz, enhance the high flow rate signal but make the response far from linear.

The 15 kHz to 51 kHz bandwidth curve is reproduced alone in FIG. 4. A continuous curve 120 is used to joins up five measured points 142, 44, 46, 48, 50 (using a smoothing function), and a straight line fit to this is shown by dotted line 52. For example, point 44 can be considered as relating to a dripping tap. Pouring a glass of water has a flow rate of around 1101/min and running a bath or having a garden sprinkler on has a flow rate of around 1201/min.

The minimum flow rate that can be measured before the response becomes non-linear (perhaps due to the domination of noise) is approximately 0.21/min, although this is obviously subject to confirmation when more accurate and comprehensive measurements can be made.

Examining the range of flow rates likely to be experienced in the domestic environment, the estimates given in Table 4 below may be obtained. Also included in Table 4 are the estimated liminal flow rates, and the rate corresponding to a dripping tap, to scope the range of flow rates that might be experienced. Some examples of these flow rates are included in FIG. 4 for comparison.

TABLE 3

| | Estimated Peak | Integrated Flow |
|---|---|---|
| Function | Flow Rate (l/mm) | (l) |
| Bath being run | 120 | 11140 |
| Lawn sprinkler | 120 | — |
| Basin being filled | 120 | 5 |
| Glass of water being | 110 | 0.3 |
| filled | | |
| Liminal flow rate | 0.2 | — |
| Leakage (dripping) | <0.005 | — |

Although the best-fit straight line is shown extrapolated up to a flow rate of 1201/min, subsequent measurements have shown that this should not be assumed.

In order to establish a more general position, a laboratory system was prepared and measurements taken which indicate features which are not evident from the foregoing measurements. These measurements are illustrated in FIG. 5.

In FIG. 5, the relationship between relative magnitude of 10 acceleration and frequency is shown for four flow rates as indicated by curves 60, 62, 64, 66. Curve 60 corresponds to a flow rate of 1201/min, curve 62 to a flow rate of 1161/min, curve 64 to a flow rate of 1101/min and curve 66 to a flow rate of 41/min. These flow rates extend into a higher flow range than that illustrated in FIG. 2, that is, up to 1201/min instead of 1121/min. These measurements therefore cover flow rates up to the maximum likely in a domestic situation, but were limited at the lower end by the measuring apparatus to 41/min.

It is to be noted that the curves shown in FIG. 5 are rather different to those in FIG. 2 and that the ordinate axis is not related to an absolute measure of power and is therefore not necessarily comparable with that of FIG. 2.

FIG. 6 illustrates the relationship between integrated power and flow rate for bandwidth measurements. The curves 70, 72, 74, 76, 78 correspond to respective bandwidths as shown in Table 4 below.

TABLE 4

| Curve | 70 | 72 | 74 | 76 | 78 |
|---|---|---|---|---|---|
| Bandwidth | 0-51.2 | 0.256-51.2 | 15.1-51.2 | 15.1-130 | 0-15.1 |
| (kHz) | | | | | |

As can be seen in FIG. 6, the main factor which has been identified from the measurements is that the relative magnitude of the sensor output does not climb monotonically with increasing flow rate, but reaches a peak and then decays again for higher flow rates. The turning point for the laboratory system occurs at around 1101/min for wide bandwidth measurements, which is in line with the maximum flow rate obtained previously. A further observation is that, for the laboratory system, the results in the lower flow regime are not linearly related to flow rate.

It is believed, however, that both sets of results are experimentally valid. Apart from the non-linearity, the main issue for consideration is the falling away of the output at higher flow rates.

A study was made of integrated power in different frequency regimes and the results obtained are shown in FIG. 7. Here, curve 80 corresponds to a bandwidth of 0 to 51.2 kHz, curve 82 to a bandwidth of 110 to 112 kHz and curve 84 to a bandwidth of 0 to 2 kHz, the bandwidth of curves 82 and 84 falling within the bandwidth of curve 80. It can readily be seen that the integrated power over the entire frequency range peaks around 1101/min (curve 80), but when bandpassing the frequency ranges as shown by curves 82 and 84, the peak can be seen to be shifted.

Boxes 86, 88 indicate regions of the complete frequency range measurement where a narrow band measurement could be used to resolve ambiguities in the estimation of the flow rate. The principle is as follows: a set of measurements is made in three frequency bands, and the outputs compared and thresholded. With suitable calibration, the relative amplitudes in each band provide an unambiguous output of flow rate and may aid in achieving high repeatability and accuracy.

Thus, a simple vibration sensor should be able to measure flows from a usefully low level up to mid-ranges of flow rate. In some circumstances, the response of this regime may be linear, and in others non-linear.

It is believed that such a sensor could not measure the flow from a dripping tap. However, these leaks are seldom a significant problem in relation to the kind of design requirements for which it has been developed—protecting against damage to the house, or the cost of losing substantial amounts of water.

Similar measurements to those made at a point around 2.5 m from an outlet, in this case a tap, were also made 15 m away from an outlet. It was found that the spectral energy falls off at much lower frequencies and the shape of the spectra is different. In this latter case, the outlet was a cistern refilling after being flushed. Twenty spectra were recorded; the first immediately after the ball valve opened, that is, when the cistern was flushed, and the remainder at three-second intervals thereafter. The sequence of acceleration spectra measured on the inlet pipe in this case is shown in FIG. 8.

As in the short-range measurements, that is, at around 2.5 m, strong vibration was measured over a wide range of frequencies during the high initial flow rates. The vibration level decreased steadily over time, as the flow rate fell, although the structure of peaks and troughs in the vibration spectrum remained fairly constant. Actual flow rates were not available for these measurements. Note that these spectra have half the frequency span of the spectra in FIG. 2.

Observations of this process suggest that the flow into the cistern after emptying is approximately constant during the main filling period of about 70 seconds. Another 120 seconds is then needed to fill the cistern completely, during which period the flow rate reduces. So, for the period recorded, of 60 seconds, one would expect the flow to be fairly constant.

The inlet pipe vibration spectra measured with outflow into the cistern are very different from those measured with outflow through a tap, although this may well be because of the much greater distance from the measurement point to the orifice or outlet rather than the type of valve. The pattern of peaks and troughs is different, and there is no detectable vibration at frequencies above about 15 kHz, whereas the tap vibration spectra extend up to 50 kHz.

A conclusion may be reached, tentatively, that (i) the much longer range from the source to the sensor has made the measurement process very insensitive, and (ii) a rather different sound generation process may be occurring with the cistern flow. In fact, the poor performance at long ranges is an advantage to the use of such sensors in a practical architecture, in that it will enable several sensors to be placed throughout the system and to function largely independently of each other, assuming higher frequency signals are selected and the low frequency energy is rejected.

However, the object of the present invention is to be able to detect the presence of leaks rather than flows through taps and valves. Measurements were taken of a pipe with water flowing out of a tap. A small puncture was then inserted in a pipe to simulate the presence of a leak. Further measurements were taken of the same pipe with water flowing out of the tap. The results obtained are shown in FIG. 9.

In FIG. 9, curve 90 illustrates the flow through the tap without the simulated leak, curve 92 illustrates the flow through the tap with the simulated leak, and curve 94 illustrates the leak flow with the tap turned off. It can be seen that, over a range of frequencies from about 6 kHz up to 50 kHz, a much stronger signal is emitted by the leak—but only if the tap is not turned on. This suggests that smaller flows characterised by leaks will provide characteristic signals that can be used by a fairly simple processor to determine the type of water flow that is being measured and propose the kind of response appropriate to such flows, for example, leakage, inadvertent flow, intended flows etc.

An exemplary domestic plumbing system 110 is shown in FIG. 10. The plumbing system 110 comprises a cold water tank 112, a hot water tank 114, a bathroom 116, a cloakroom 118, a washing machine 120, and an outside tap 122 which are connected together by lengths of pipe indicated generally by reference numerals 128, 130, 132, 134, 136, 138, 140, 142. Although not shown in the plumbing system 110, it will readily be appreciated that sinks located in kitchens and utility rooms as well as dishwashers could also be included in such a plumbing system.

The cold water tank 112 is typically located in a loft or attic of the house and has the potential to cause substantial damage if there is a leakage associated with it. The cold water tank 112 is connected directly to the mains supply 124 via stopcock 126 and pipe 128.

The hot water tank 114 and the bathroom 116 are typically located on an upper floor of the house, the hot water tank 114 being located in an airing cupboard (not shown) which may be located within the bathroom 116, in another room or on the landing. The hot water tank 114 is connected to receive cold water from the cold water tank 112 via pipes 132, 136 and to provide an overflow into the cold water tank 112 via pipe 142. It will readily be appreciated that the hot water tank 114 is connected by pipe (not shown) to supply hot water to the bathroom 116, the cloakroom 118 and the washing machine 120 as well as other sinks, baths or showers (not shown) which may be present in the house.

The cloakroom 118 is typically located on a lower floor of the house as is the washing machine 120. The outside tap 122 is located on a wall externally to the house. In the illustrated system, the cloakroom 118 is connected to the mains supply 124 via stopcock 126 via pipe 130 with the washing machine 120 and outside tap 122 connected in series with the cloakroom 118 by means of pipes 138, 140 as shown.

In accordance with the present invention, the system 110 also includes a plurality of flow sensor units 144, 146, 148, 150, 152, 154, 156, 158 connected to sense flow of water in the pipes 128, 130, 132, 134, 136, 138, 140. Each sensor is of the same type as that earlier described with reference to FIG. 1. It will be noted that the sensor units are located on each pipe so as to be associated with possible sources of leakage.

Each flow sensor unit 144, 146, 148, 150, 152, 154, 156, 158 is clipped onto its associated length of pipe 128, 130, 132, 134, 136, 138, 140 and its associated cable 160 is connected to a processing unit (not shown) as shown in FIG. 11. Only flow sensor unit 144 on pipe 128 is shown for simplicity, but each of the other sensors will be arranged in the same way on their associated length of pipe with their associated cable connected to the processing unit 14.

The flow sensor units 144, 146, 148, 150, 152, 154, 156, 158 are attached to the pipes 128, 130, 132, 134, 136, 138, 140 in the plumbing system 110 in such a way that flow of water along each part thereof is monitored. As mentioned above, the use of a single, inexpensive sensor unit can be considered also, although its benefit will be less, as it will be more difficult to pinpoint the source of a leakage.

As will readily be appreciated, the flow sensor units 144, 146, 148, 150, 152, 154, 156, 158 and the processing unit 14 comprise a sensing system in accordance with the present invention. Ideally, each flow sensor unit 144, 146, 148, 150, 152, 154, 156, 158 is a relatively simple device to reduce the overall cost of implementing the system. By using a simple flow sensor unit or flow meter, the demands on the rest of the sensing system become somewhat greater, to balance out the deficiencies of the flow sensor unit. However, this can be done by the use of electronics and signal processing, thereby providing an inexpensive system.

A domestic plumbing system consists of several lengths of pipe joined together, and connecting various control devices, cisterns and output orifices as described above with reference to FIG. 10. Water flows into the system through one inlet pipe 24, and flows out via several outlets 112, 114, 116, 118, 120. Any outflow from the plumbing system must be produced either by an equal inflow in the inlet pipe 124 or from some cistern. For a part of the system with no cistern, measuring the flow through the inlet pipe 124 will detect any outflow, whether it be normal usage or a leak.

The mains water supply 124 comes into the house and passes through the inside stopcock 126 as shown in FIG. 10. It immediately passes through the pipe 128 that has sensor 144 which determines the amount of flow coming from the mains supply 124 into the house, but not which part of the house it is being used in. A single sensor at this point may be satisfactory in a simple situation. So, this would be acceptable if the objective were to protect the house against the risk of leakage or flooding, if the measurement could be made when one was certain that no water was being drawn deliberately or cistern being filled.

One enhancement of the system is to install the sensor 158 just inside the house at the other side, in the pipe 140 which leads out to the garden tap 122. In this way, if tap 122 is inadvertently left running or freezing conditions have resulted in the pipe 140 bursting, a more directed alerting to possible problems in the plumbing is available.

A further addition is to include sensor 154 in pipe 130. This will enable the system to determine differences between the flow to the outside tap 122 on the ground floor, what flows to the downstairs equipment (e.g. cloakroom 118) and what is flowing to the first floor. Again, with some simple logical and measurement capability, localisation of the water demand or leakage can be quickly made by the processing unit 14.

A potential source of considerable risk is the washing machine 120 as described above. Thus, sensor 156 is shown connected close to the machine 120, preferably on the spur that comes from the pipe 138.

For the upstairs, further flow sensors may be used. Sensor 146 determines the flow into the cold water tank 112, which should not demand water for long periods unless either a pipe leading from it is demanding water, or the tank is overflowing for some reason, such as a failing ballcock (not shown).

Sensor 148 can be used to compare the input to the cold water tank 112 with the demand from the pipes 132, 134, 136 connected to it.

Of the pipes connected to the cold water tank 112, sensors 150 and 152 can be used to determine the flows to the upstairs hot water tank 114, and basins and lavatories, for example, bathroom 116. [The hot water system is not included in this simple description of the alerting system.]

In accordance with a system of the present invention, each sensor is connected to transmit sensor data to the processing unit 14 which is located in a central position (possibly by the front door). The processing unit makes comparisons between sensor data and various input data that describes the likely or expected states of flow, perhaps with reference to time of day, or whether the occupants are on holiday, at work or at home. Outputs from the sensors may be communicated to the processing unit in several ways, for example:

using a radio technique such as ‘Bluetooth’;

using a mains wiring system;

using an ultrasonic technique along the pipes;

making use of some already-installed system, such as a security system;

using an in-air ultrasonic communications; or using an inductive loop system.

However, the choice of the means of communication between each sensor and the processing unit will depend on factors such as:

battery life if the sensors can be powered by battery;

the permanence of the installation;

the requirement for additional wiring; and

the use of the pipes or the house electric wiring for conveying the sensor data to the processing unit.

If the processing unit 14 determines that the presence and, ideally, the location of a leakage, this information is used to alert a consumer that there is a problem. This information could be used locally, or in the future considered for connecting to a micro-web server, so that it could be made available to relatives, neighbours, the local police or other interested/responsible parties.

It is also envisaged that the system in accordance with the present invention could interact with domestic appliances which may be the cause of leakages, for example, washing machines and dishwashers. The sensor unit associated with such appliances could be powered from the mains and could be capable of determining whether the appliance is in use or not.

One way for implementing this is to include an adapter which fits into a standard electrical socket and into which the plug of the appliance is inserted. The adapter may include a pre-amplifier/buffer unit for connection to the sensor via a short length of wire, the sensor being located on adjacent pipe.

The processing unit 14 may be used to actuate motorised valves to isolate leaking parts of the system or indeed to shut off the water supply completely by activation of the stopcock 126 for example.

It will be appreciated that this could provide an intelligent system which can determine if the sensor data received by the processing unit is due to use of the appliance or to due to a leakage.

The processing unit comprises a simple computer system which can accommodate or allow for shortfalls in the sensor units due to their relative cheapness.

The processing unit may include a display panel which indicates whether each sensor is working correctly and whether the data being received at the processing unit relates to a leakage or to standard operation of the pipes to which the sensors are attached.

Although the present invention has been described with reference to water systems, it will be appreciated that it is equally applicable to systems carrying other types of fluids.

1. A method of determining the presence of a leakage from a fluid system comprising sensing the vibrations induced by passage of the fluid through the leakages; segmenting the sensed vibrations into at least two spectral bands; comparing the amplitudes of the spectral bands with predetermined values to determine flow rate.

2. A method according to claim 1, further comprising attaching a sensor to the fluid system to obtain data therefrom indicative of fluid flow therethrough.

3. A method according to claim 2, wherein the sensor includes a piezo-electric material.

4. A method according to claim 3, wherein the sensor includes a PVDF film.

5. A method according to claim 2, wherein the sensor comprises one of a strain gauge, geophone or hydrophone.

6. A method of determining leakage from a fluid system substantially as hereinbefore described with reference to the accompanying drawings.

7. Apparatus for determining the presence of a leakage from a fluid system comprising a vibration sensor for sensing vibrations induced by passage of the fluid through the leakages, a segmentor for segmenting the sensed vibrations into at least two spectral bands, a comparitor for comparing the amplitudes of the spectral bands with predetermined values to determine flow rate.

8. Apparatus as claimed in claim 7 wherein the sensor includes a piezo-electric material.

9. Apparatus as claimed in claim 8 wherein the sensor includes a PVDF film.

10. Apparatus as claimed in claim 8 wherein the sensor comprises one of a train gauge, geophone or hydrophone.

11. Apparatus for determining leakage from a fluid system substantially as hereinbefore described with reference to the drawings.

12. A leakage detection system for use in a fluid carrying system which leakage detection system comprising:
at least one sensor mountable to the exterior of a pipe of the fluid carrying system which sensor comprising a vibration sensor for measuring vibrations in the pipe caused by fluid flow in the pipe and to provide output signals indicative of the vibrations; and
a processing unit for receiving signals from at least one sensor and for comparing the received signals with reference data to determine the presence of a leak.

13. A leakage detection system as claimed in claim 12 including apparatus as claimed in claims 7 to 11.

14. A leakage detection system substantially as hereinbefore described with reference to and as illustrated by the drawings.
